(19) United States
(12) Patent Application Publication
(10) Pub. No.: US 2021/0261274 A1
(43) Pub. Date: Aug. 26, 2021

(54) METHOD FOR OBSERVING A PLANET USING OBSERVATION SATELLITES ORBITING THE PLANET

(71) Applicant: B-Space, Brest (FR)

(72) Inventor: Christophe MESSAGER, Brest (FR)

(21) Appl. No.: 17/261,395

(22) PCT Filed: Jul. 17, 2019
(86) PCT No.: PCT/EP2019/069264

§ 371 Date: Jan. 19, 2021

(30) Foreign Application Priority Data
Jul. 19, 2018 (FR) 18 56711

(51) Int. Cl. B64G 1/10; G01W 1/02; G01S 13/95

(52) U.S. Cl. CPC B64G 1/1021; G01W 1/02; B64G 2001/1035; B64G 2001/1042; B64G 2001/1028; G01S 13/955

(57) ABSTRACT

An observation method comprises a step for calculating first predicted observation data for a first area of interest as a function of second observation data acquired by a second observation satellite in stationary orbit for the first area of interest and/or first observation data acquired by the first observation satellite for first observation areas located near the first area of interest, and reference observation data previously recorded in a database; and/or a step for calculating second predicted observation data, for a second area of interest as a function of first observation data acquired by the first observation satellite in drift orbit and reference observation data.

### TECHNICAL FIELD

The present invention relates to the field of observing a planet using observation satellites orbiting the planet.

### BACKGROUND

An observation satellite orbiting a planet can be in stationary orbit, in which case the observation satellite is immobile relative to the surface of this planet, or in drift orbit, in which case the observation satellite is in motion relative to the surface of this planet.

An observation satellite in stationary orbit allows continuous observation of a fixed area of the planet. This fixed area is limited to a disc, or more specifically a spherical cap of the surface of the planet.

A satellite in drift orbit rotates around the planet while observing an observation area (generally called the “swath”), which moves over the planet along a trajectory corresponding to a projection of the orbit of the satellite in drift orbit over the surface of the planet. Each area observed by the observation satellite in drift orbit is observed at a frequency called revisitation frequency.

### SUMMARY OF THE INVENTION

One of the aims of the invention is to provide an observation method that makes it possible to collect reliable and comprehensive data in space and in time.

To that end, the invention proposes a method for observing a planet implement by computer, the method comprising:
a step for calculating first predicted observation data for a first area of interest and a first time period during which the first area of interest has not been observed by a first observation satellite in drift orbit, as a function of second observation data acquired by a second observation satellite in stationary orbit, for the first area of interest and during said first time period, and/or first observation data acquired by the first observation satellite, for first observation areas located near the first area of interest and during said first time period and reference observation data previously recorded in a database; and/or
a step for calculating second predicted observation data, for a second area of interest and a second time period during which the area of interest has not been observed by the second observation satellite in stationary orbit, as a function of first observation data acquired by the first observation satellite in drift orbit for the second area of interest and during said second time period, and reference observation data previously recorded in the database.

The formation of a database containing prerecorded reference observation data makes it possible to predict, for example by machine learning, which types of first observation data and/or second observation data could have been observed, whereas these data are missing.

It is thus possible, when one has first observation data but not second observation data, to predict second observation data that could have been observed by the second observation satellite and/or, when one has second observation data but not first observation data, to predict first observation data that could have been observed by the first observation satellite, in particular when the reference observation data contain joint observations, each joint observation comprising first observation data and second observation data acquired for a same joint observation area and a same joint observation time period.

The formation of such a database also makes it possible to determine, for example by machine learning, first observation data that could have been observed by a satellite in drift orbit in an area of interest that was not observed by this satellite in drift orbit during a given time period, as a function of first observation data acquired by the satellite in drift orbit during the given time period in observation areas located near the area of interest, and reference observation data previously recorded in the database, in particular as a function of first reference observation data or as a function of joint reference observations.

It is thus possible to reconstitute observation data for an extended area from first observation data relative to first observation areas not completely covering the extended area.

According to specific embodiments, the observation method may comprise one or several of the following optional features.
updating the database with observation data done by the first observation satellite and/or the second observation satellite;
updating the database with joint observations made by the first observation satellite and the second observation satellite;
the reference observation data contain joint reference observations, each joint observation comprising first observation data and second observation data acquired for a same joint observation area and in a same joint observation time period;
each calculating step is done by a predictive algorithm updated by machine learning as a function of reference observation data previously recorded in the database for at least one area of interest observed jointly by the first observation satellite and the second observation satellite;
the second observation data make it possible to detect meteorological phenomena in the atmosphere of the planet, composition variations of the atmosphere, variations on the surface of or inside the planet, and variations in electrical, electromagnetic, gravitational and quantum fields, irrespective of the wavelengths;
the first observation data make it possible to detect meteorological phenomena on the surface of the planet, composition variations of the atmosphere, variations on the surface of or inside the planet, and variations in electrical, electromagnetic, gravitational and quantum fields, irrespective of the wavelengths;
an observation satellite comprises at least one onboard image sensor.
each image sensor operates in any wavelength range, for example one or several from the visible wavelengths, infrared wavelengths and microwaves;
an observation satellite has at least one onboard radar sensor, for example a synthetic-aperture radar sensor; and
the planet is Earth.

The invention also relates to a system for observing a planet configured to implement the observation method as defined above, the observation system comprising a first observation satellite in drift orbit and a second observation satellite in stationary orbit, a database in which the reference observation data are stored, and a computer on which a prediction algorithm is installed configured to implement each calculation step during its execution by the computer.

The invention also relates to a computer program product comprising code instructions for carrying out an observation method as defined above.

### BRIEF DESCRIPTION OF THE DRAWINGS

The invention and its advantages will be better understood upon reading the following description, provided solely as a non-limiting example, and done in reference to the appended drawings, in which:

FIG. 1 is a schematic view of observation satellites of a satellite observation system of a planet;

FIG. 2 is a schematic view of the satellite observation system;

FIGS. 3 to 6 are schematic views illustrating areas of interest located between observation areas.

### DETAILED DESCRIPTION OF PREFERRED EMBODIMENTS

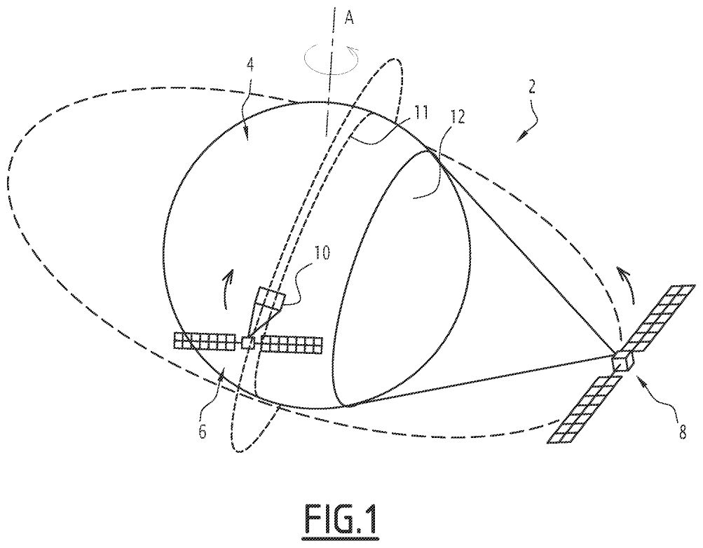

In FIG. 1, a satellite observation system 2 configured to observe a planet 4 has a first observation satellite 6 in drift orbit around the planet 4 and a second observation satellite 8 in stationary orbit around the planet 4.

The planet 4 has an axis of rotation A and rotates around itself about this axis of rotation A. The axis of rotation A passes through two points of the planet 4, which are two diametrically opposite points of the planet 4. The planet 4 is for example Earth.

The first observation satellite 6 is in motion relative to the surface of the planet 4 and observes a first observation area 10 at a given moment, this first observation area 10 (the swath) moving over the surface of the planet 4 along a trajectory 11 that is a projection of the orbit of the first observation satellite over the surface of the planet.

Each first observation area 10 observed by the first observation satellite 6 is observed with a frequency called revisitation frequency. Due to the rotation of the planet 4, the first observation satellite 6 does not pass back over the same observation areas upon each revolution of the first observation satellite around the planet.

In the illustrated example, the first observation satellite 6 moves along a substantially polar low orbit, that is to say, located in a plane containing the axis of rotation A or forming a slight angle with the axis of rotation A. The revisitation frequency is then a multiple of the rotation frequency of the first observation satellite 6 around the planet 4.

In a variant, the first observation satellite 6 moves along a nonpolar low orbit, for example of the equatorial type or the like.

The second observation satellite 8 is immobile relative to the surface of the planet 4, and continuously observes the fixed second observation area 12 of the planet 4. The second observation satellite 8 rotates around the planet 4 at the same speed as the rotation of the planet 4 around its rotation axis A.

The orbit of the second observation satellite 8 is for example in an equatorial plane.

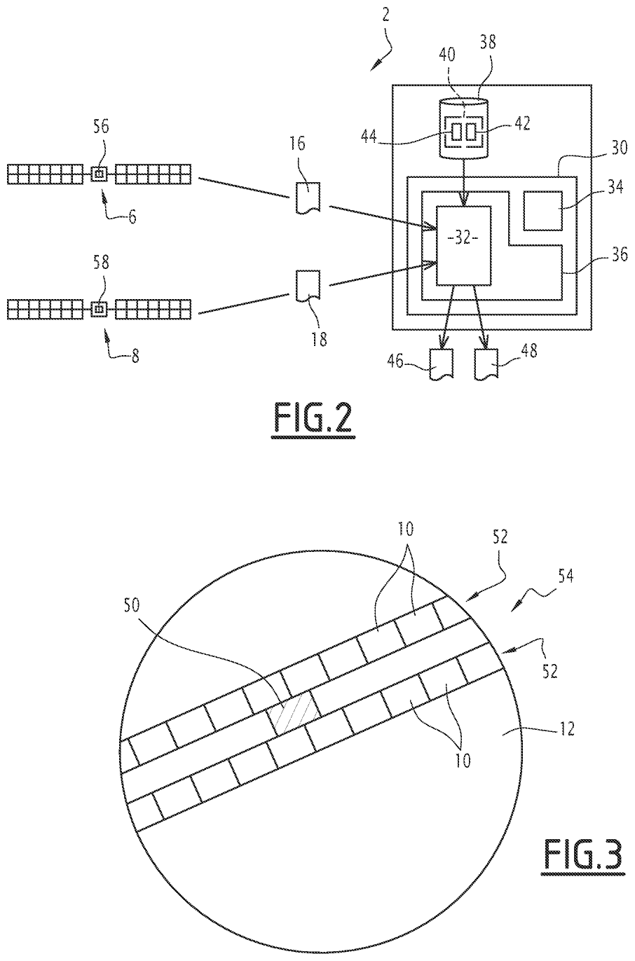

As illustrated in FIG. 2, the first observation satellite 6 acquires first observation data 16 and the second observation satellite 8 acquires second observation data 18.

The first observation data 16 and the second observation data 18 are for example of different types. In a variant, they can be of the same type.

The first observations 16 for example make it possible to detect a first type of phenomenon and the second observation data 18 make it possible to detect a second type of phenomenon different from or identical to the first type of phenomenon.

When the first type of phenomenon and the second type of phenomenon are different, the phenomena of the first type and the second type are preferably related.

“Phenomena of related types” means that the occurrence of a phenomenon of the first type in an area can be accompanied by the occurrence of a phenomenon of the second type in this same area.

The satellite observation system 2 comprises a computer 30 configured to execute a predictive algorithm 32 carried out by computer.

The computer 30 for example comprises a processor 34 and a memory 36 in which the predictive algorithm 32 is recorded, the predictive algorithm 32 having code instructions executable by the processor 34 and configured to carry out an observation method when the algorithm is executed by the processor 34.

The satellite observation system 2 comprises a database 38 in which reference observation data are recorded.

The reference observation data for example comprise first reference observation data and/or second reference observation data.

The first reference observation data and/or the second reference observation data contained in the database 38 have been acquired by the first observation satellite 6, the second observation satellite 8 and/or one or several other observation satellites of the satellite observation system 2, each of these other satellites being configured to collect first observation data and/or second observation data.

In other words, the database 38 is supplied with observation data by the first observation satellite 6, the second observation satellite 8 and/or by other satellites configured to acquire the same types of observation data.

Advantageously, the reference observation data comprise joint reference observations 40, each joint reference observation 40 comprising first reference observation data 42 and second reference observations 44 acquired jointly, that is to say, in a same joint observation time period and for a same joint observation area.

The joint observation time period is a duration that is a function of the variation speed of the observed phenomena. This period can be very short—1 second—for fast natural phenomena (for example, gusts of wind) to several minutes (clouds), several hours or even days in the case of slower phenomena (for example, erosion), to years (for example, variation of the magnetic field of the planet).

The first reference observation data 42 and the second reference observation data 44 of each joint reference observation 40 have been acquired jointly by the first observation satellite 6 and the second observation satellite 8, or by other observation satellites of the satellite observation system 2, each of these other satellites being configured to collect first observation data and/or second observation data.

In other words, the database 38 is supplied with joint observations by the first observation satellite 6 and the second observation satellite 8 and/or by other satellites configured to acquire the same types of observation data.

The predictive algorithm 32 is configured to implement an observation method from first observation data 16 acquired by the first observation satellite 6 and/or second observation data 18 acquired by the second observation satellite 8.

The observation method comprises:
a step for calculating first predicted observation data 46 for a first area of interest and a first time period during which the first area of interest has not been observed by a first observation satellite 6, as a function, on the one hand, of second observation data 18 acquired by the second observation satellite 8, for the first area of interest and during said first time period, and/or first observation data 16 acquired by the first observation satellite 6, for first observation areas located near the first area of interest and during said first time period, and, on the other hand, reference observation data previously recorded in the database 38, for example as a function of joint observations 40; and/or
a step for calculating second predicted observation data 48, for a second area of interest and a second time period during which the area of interest has not been observed by the second observation satellite, as a function of first observation data 16 acquired by the first observation satellite 6 for the second area of interest and during said second time period, and reference observation data previously recorded in the database 38, for example as a function of joint reference observations 40.

The calculation of the first predicted observation data 46 and/or second predicted observation data 48 is for example based on machine learning done by the predictive algorithm 32 from reference observation data in the database 38, for example as a function of joint reference observations 40 previously recorded in the database 38.

The multitude of reference observations prerecorded in the database 38 makes it possible to predict which first observation data and/or which second observation data could have been observed in an area of interest and in a given time period whereas one does not have, or at least not completely, these first observation data and/or these second observation data for the area of interest.

In particular, prerecorded joint reference observations 40 make it possible, by machine learning, to know which type of first observation data should be observed in the presence of second observation data 18 acquired by the second observation satellite 8 in the considered time period, namely which type of second observation data should be observed in the presence of first observation data 16 acquired by the first observation satellite 6 in the considered time period, and/or to predict which first observation data should be observed by the first observation satellite 6 in an area of interest as a function of first observation data acquired by the first observation satellite 6 in observation areas located nearby.

The observation method for example comprises calculating first predicted observation data 46 for a first area of interest 50 and a first time period during which the first area of interest 50 has not been observed by the first observation satellite 6, no first observation datum 16 acquired by the first observation satellite 6 therefore being available for the considered time period.

Thus, despite the absence of first observation data 16 acquired by the first observation satellite 6 for the first area of interest 50 in the first considered time period, the predictive algorithm 32 provides first predicted observation data 46.

The predictive algorithm 32 associated with the database 38 containing joint reference observations 40 thus makes it possible to predict what could have been observed by the first observation satellite 6 in the first area of interest 50 and in the first considered time period during which the first observation satellite 6 did not observe this first area of interest 50.

As illustrated in FIG. 3, the first observation satellite 6 successively observes a series of first observation areas 10 distributed over the surface of the planet along the trajectory of the first observation satellite 6.

The second observation satellite 8 continuously observes the fixed second observation area 12 on the surface of the observed planet 4.

Due to the rotation of the planet 4 about its axis of rotation A and the drift orbit of the first observation satellite 6, the trajectory of the first observation satellite 6 periodically passes over the second observation area 12, such that first observation areas 10 are located in the second observation area 12.

The first observation satellite 6 for example observes two successive observation bands 52 separated by a non-observed band 54 that is not observed by the first observation satellite 6 during the time period separating the observations of the two successive observation bands 52.

The distance between the two successive observation bands 52 can correspond to the rotation of the observed planet 4 between the two passages of the first observation satellite 6.

Thus, considering a first area of interest 50 located in this non-observed band 54, no first datum 16 has been acquired for this first area of interest 50 in a time period located between the two successive passages of the first observation satellite 6. Conversely, second data 18 have been acquired by the second observation satellite 8.

The observation method implemented by the predictive algorithm 32 makes it possible to predict predicted first observation data 46 corresponding to what could have been observed by the first observation satellite 16, as a function of second observation data 18 acquired by the second observation satellite 8 during the considered time period.

The prediction can be made for first areas of interest 50 located in the second fixed observation area 12 and that have not been observed by the first observation satellite 6 during successive passages of the first observation satellite 6 above this second observation area 12, so as to predict predicted first observation data 46 for these first areas of interest 50 and thus to reconstruct acquired or predicted first observation data 16, 46 for all of the fixed second observation area 12.

Thus, although the first observation satellite 6 does not cover the entire second observation area 12 in a determined time period, it is possible to obtain acquired or predicted first observation data 16, 46 for the entire fixed second observation area 12.

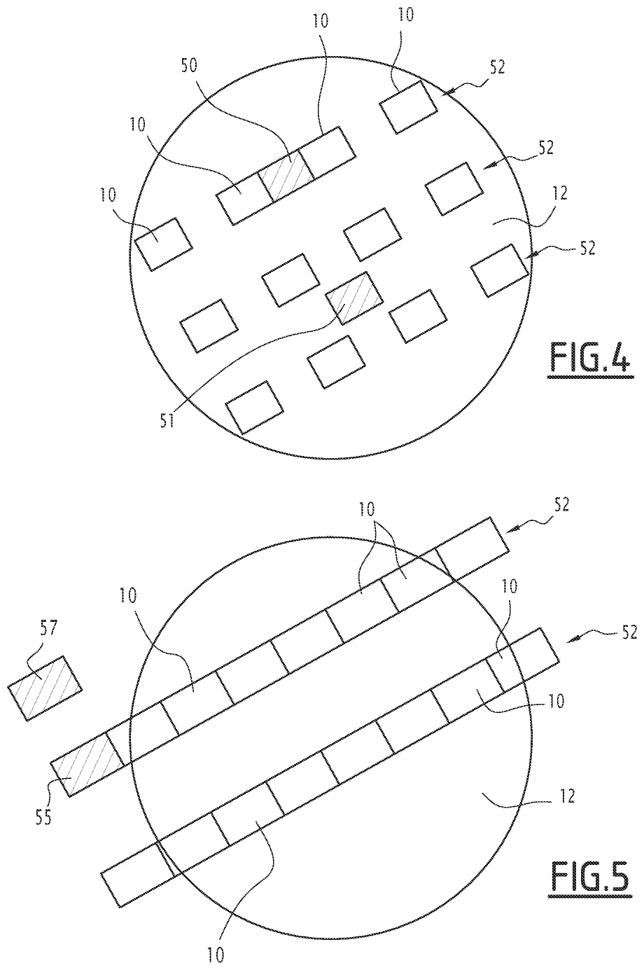

As illustrated in FIG. 4, it is possible for the acquisition frequency of the first observation data 16 by the first observation satellite 6 to be such that two first observation areas 10 observed successively by the first observation satellite 6 along its drift orbit are spaced apart by a first area of interest 50 not observed by the first observation satellite 6 in the first time period located between the observations of the first two successive observation areas 10.

In other words, the first observation satellite 6 observes the planet surface 4 by acquiring first observation data 16 for a series of first discrete observation areas 10 alternating with non-observed areas, during a same revolution of the first observation satellite 6 around the planet 4.

It is also possible for the acquisition of first data 16 by the first observation satellite 6 to be temporarily interrupted, such that there is a first non-observed area of interest 50 separating two first observation areas 10 successively observed by the first observation satellite 6 during a same revolution of the first observation satellite 6 around the planet 4.

Therefore, in one exemplary embodiment, the observation method comprises calculating predicted first observation data 46 for a first area of interest 50 located between two first observation areas 10 successively observed by the first observation satellite 6 during a same revolution of the first observation satellite 6 around the planet 4, the first area of interest 50 not having been observed by the first observation satellite 6.

As also illustrated in FIG. 4, the observation method comprises, in a variant or optionally, calculating predicted first observation data 46 for a first area of interest 51 that is located in the second observation area 12, which was not observed by the first observation satellite 6 during a first time period during which the first observation satellite 6 has observed first observation areas 10 located in the second observation area 12, the first area of interest 51 not being located in any of the alignments of first observation areas 10 of the successive passages of the first observation satellite 6 above the second observation area in the first time period.

The first observation areas 10 are located along lines corresponding to the successive passages of the first observation satellite 6 above the second observation area 12, the first area of interest 51 being located outside these lines.

The observation method thus makes it possible, by combining first areas of interest 50 and 51, to reconstitute what the first observation satellite 6 would have observed during a determined time period over an extended area for which the first observation satellite 6 acquired first observation data 16 only in first observation areas 10 located in the extended area while being spaced apart from one another.

In other words, from fragmented data in the extended area, it is thus possible to predict first observation data for the entire extended area.

As illustrated in FIG. 5, the first observation satellite 6 observes first observation areas 10 that are located outside the fixed second observation area 12 continuously observed by the second observation satellite 8, and for which the second observation satellite 8 does not acquire second observation data 18.

In one exemplary embodiment, the observation method comprises calculating predicted second observation data 48 for a second area of interest 55, 57 not observed by the second observation satellite 8 during a second considered time period, as a function of:
on the one hand, first observation data 16 acquired by the first observation satellite 6 during the second considered time period, for example for the second area of interest 55, and
on the other hand, reference observation data previously recorded in the database 38, in particular joint reference observation data 40 previously recorded in the database 38.

This makes it possible to calculate predicted second observation data 48 in second areas of interest 55 not observed by the second observation satellite 8, and thus to virtually enlarge the second observation area 12 covered by the second observation satellite 8.

As illustrated in FIG. 5, an area of interest 55 can coincide with an observation area 10 of the first observation satellite 6 observed by the latter during the second time period, in which case the predicted second observation data 46 are calculated as a function of first observation data acquired for the area of interest 55, or an area of interest 57 can be different from the observation areas 10 of the first observation satellite 6 observed by the latter during the second time period.

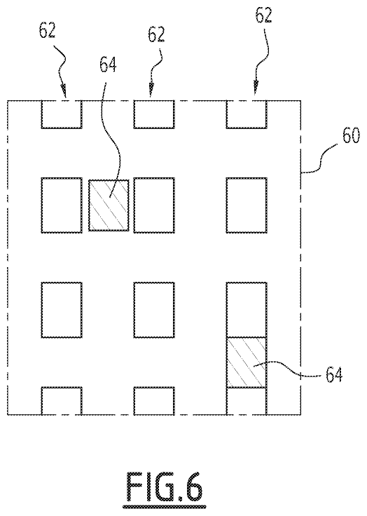

As illustrated in FIG. 6, in a first time period, the first observation satellite 6 acquires first observation data 16 for first observation areas 10 that are located in an extended area 60. The first observation areas 10 here are aligned along parallel observation lines 62 corresponding to successive passages of the first observation satellite 6 above the extended area 60. The observation lines 62 are spaced apart from one another. The first observation areas 10 of each observation line 62 are spaced apart (as illustrated) or contiguous.

In one exemplary embodiment, the observation method comprises calculating first predicted observation data 46 for at least one area of interest 64 adjacent to one or several observation areas 10 and for the considered time period, as a function of the first observation data 16 acquired by the first satellite and reference observation data previously recorded in the database 38.

In one embodiment, the reference observation data previously recorded in the database 38 and taken into account to calculate first predicted observation data 46 are exclusively first reference observation data. In this case, the database 38 can comprise only first reference observation data.

In a variant, the reference observation data previously recorded in the database 38 and taken into account to calculate first predicted observation data 46 comprise first reference observation data and second reference observation data. This makes it possible to have more data, which allows better learning.

In one specific embodiment, the reference observation data previously recorded in the database 38 and taken into account to calculate the predicted first observation data 46 comprise or are made up of joint reference observations 40. This is favorable to the learning and the reliability of the prediction.

This calculation is done in particular without taking account of the second observation data 18 acquired by the second observation satellite 8 during the same time period as the first observation data 16 acquired for the first observation areas 10. The extended area 60 is for example separate from the second observation area 12.

Indeed, the collection of joint reference observation data 40, in particular associated with machine learning, makes it possible to predict first predicted observation data 46 for non-observed areas of interest from acquired first observation data 16 for adjacent observation areas 10.

The method makes it possible to reconstruct first observation data for the extended area 60 from first observation data acquired for first observation areas 10 located in the extended area 60 and covering only part of the extended area 60.

The first observation satellite 6 and the second observation satellite 8 each comprise one or several sensor(s) configured to acquire the observation data.

In one exemplary embodiment, the first observation data 16 are acquired by at least one radar sensor 56 embedded in the first observation satellite 6, for example a synthetic-aperture radar sensor.

In one exemplary embodiment, the first observation data 16 make it possible to determine a wind field on the surface of the planet. Indeed, a radar sensor, in particular a synthetic-aperture radar sensor, for example makes it possible to determine the surface state of a body of water, for example the sea, which makes it possible to deduce the direction and/or force therefrom of the winds circulating on the surface of this body of water.

In one exemplary embodiment, the second observation data 18 are supplied by at least one image sensor 58 onboard the second observation satellite 8.

Each image sensor 58 can operate in any wavelength range.

Each image sensor 58 for example operates in one or several wavelength ranges among the visible wavelengths, infrared wavelengths and microwaves.

The second observation data 18 make it possible to determine the presence of meteorological phenomena in the atmosphere. A meteorological phenomenon is characterized for example by the shape, dimensions, variations speed of the shape and/or variation speed of the dimensions of clouds present in the atmosphere above the observed area.

Indeed, certain shapes and/or expanses of clouds are characteristic of specific meteorological phenomena. As an example, Cumulonimbi, which are generally the seat of storms, are clouds with a characteristic shape (anvil) with a large vertical expanse moving quickly.

Furthermore, the presence of certain meteorological phenomena is associated with specific winds on the surface of the planet. As an example, a Cumulonimbus generates ascending and descending winds, with areas of strong horizontal wind.

The joint reference observations 40, crossing first wind observation data 42 and second observation data 44 relative to meteorological phenomena, make it possible to associate the winds with the meteorological phenomena generating them.

It is next possible to predict a wind field on the surface of the planet 4 as a function of second data 18 acquired by the second observation satellite 8 and relative to the meteorological phenomena acquired by the second observations satellite 8 in a first area of interest 50 and in a first time period for which the first observation satellite 6 has not provided first observation data 16.

Conversely, it is possible to predict a meteorological phenomenon as a function of first observation data 16 relative to the winds acquired by the first observation satellite 6 in a second area of interest 55 and in a second time period for which the second observation satellite 8 has not provided second observation data 18.

In one preferred exemplary embodiment, the observed planet is Earth. In this case, the first observation satellite is for example an observation satellite such as SENTINEL, TerraSAR, CloudSat, etc. and/or the second observation satellite is for example an observation satellite such as Meteosat, Himawari, Goes, etc.

The invention is not limited to the observation of winds and meteorological phenomena on the Earth's surface.

The invention applies to other observable phenomena, for example coastal or mountain massif erosion phenomena, changes in vegetation, soil type, seismic phenomena and waves, changes in land altitude due to consolidation, collapse or inflow, etc., on the surface of or inside the Earth or any other planet.

Thus, the first observation data and/or the second observation data for example make it possible to determine composition variations of the atmosphere, variations on the surface of or inside the planet, and variations in electrical, electromagnetic, gravitational and quantum fields, irrespective of the wavelengths.

For such phenomena whose evolutions are more or less fast, the duration of the joint observation time period is for example between one second (gust of wind, seismic waves) and several hours (wet surfaces), to several days (vegetation, erosion, change of land altitude by consolidation, collapse or inflow) or years (variation of magnetic fields, for example).

The invention is based on machine learning from reference observation data previously recorded in the database 38. These reference observation data can comprise first reference observation data, second reference observation data and/or joint reference observation data. In specific embodiments, each calculating step is done as a function of first reference observation data, second reference observation data and/or joint reference observations.

1. A method for observing a planet implement by computer, the method comprising:
a step for calculating first predicted observation data for a first area of interest and a first time period during which the first area of interest has not been observed by a first observation satellite in drift orbit, as a function of:
second observation data acquired by a second observation satellite in stationary orbit, for the first area of interest and during said first time period, and/or first observation data acquired by the first observation satellite, for first observation areas located near the first area of interest and during said first time period; and
reference observation data previously recorded in a database; and/or
a step for calculating second predicted observation data, for a second area of interest and a second time period during which the area of interest has not been observed by the second observation satellite in stationary orbit, as a function of:
first observation data acquired by the first observation satellite in drift orbit and during said second time period, and
reference observation data previously recorded in the database.

2. The observation method according to claim 1, comprising updating the database with observation data done by the first observation satellite and/or the second observation satellite.

3. The observation method according to claim 1, wherein the reference observation data contain joint reference observations, each joint reference observation comprising first observation data and second observation data acquired for a same joint observation area and in a same joint observation time period.

4. The observation method according to claim 1, wherein each calculating step is done by a predictive algorithm updated by machine learning as a function of reference observation data prerecorded in the database for at least one area of interest observed jointly by the first observation satellite and the second observation satellite.

5. The observation method according to claim 1, wherein the second observation data make it possible to detect meteorological phenomena in the atmosphere of the planet, composition variations of the atmosphere, variations on the surface of or inside the planet, and variations in electrical, electromagnetic, gravitational and quantum fields, irrespective of the wavelengths.

6. The observation method according to claim 1, wherein the first observation data make it possible to detect meteorological phenomena on the surface of the planet, composition variations of the atmosphere, variations on the surface of or inside the planet, and variations in electrical, electromagnetic, gravitational and quantum fields, irrespective of the wavelengths.

7. The observation method according to claim 1, wherein an observation satellite -comprises at least one onboard image sensor.

8. The observation method according to claim 7, wherein each image sensor operates in any wavelength range, for example one or several from the visible wavelengths, infrared wavelengths and microwaves.

9. The observation method according to claim 1, wherein an observation satellite has at least one onboard radar sensor, for example a synthetic-aperture radar sensor.

10. The observation method according to claim 1, wherein the planet is Earth.

11. A system for observing a planet configured to implement the observation method according to claim 1, the observation system comprising a first observation satellite in drift orbit and a second observation satellite in stationary orbit, a database in which the reference observation data are stored, and a computer on which a prediction algorithm is installed configured to implement each calculation step during its execution by the computer.

12. A computer program product comprising code instructions for implementing an observation method according to claim 1.
